(19) United States
(12) Patent Application Publication
(10) Pub. No.: US 2025/0079960 A1
(43) Pub. Date: Mar. 6, 2025

(54) Permanent Magnet Synchronous Motor with Torque Ripple Reduction

(71) Applicant: Wisconsin Alumni Research Foundation, Madison, WI (US)

(72) Inventors: Bulent Sarlioglu, Madison, WI (US); Gokhan Cakal, Madison, WI (US)

(21) Appl. No.: 18/239,208

(22) Filed: Aug. 29, 2023

(51) Int. Cl. H02K 29/03; H02K 11/33; H02K 21/24

(52) U.S. Cl. CPC H02K 29/03; H02K 11/33; H02K 21/24

(57) ABSTRACT

An electric motor having opposed permanent magnet arrays employs overlapping offset coils positioned between the arrays to reduce torque ripple and cogging torque.

### STATEMENT REGARDING FEDERALLY SPONSORED RESEARCH OR DEVELOPMENT

--

### CROSS REFERENCE TO RELATED APPLICATION

--

### BACKGROUND OF THE INVENTION

The present invention relates to electrical motors and, in particular, to synchronous motors having permanent magnet arrays opposed about electrical coils.

Permanent magnet synchronous motors (PMSMs) have a wide range of use in high-performance high-efficiency applications. One such motor, the yokeless and segmented armature motor (YASA), promises improved torque and density using an axial field structure in which a set of circumferentially arrayed stator windings are positioned between permanent magnet rotor plates. Motors of this type can exhibit significant torque ripple and torque cogging which can cause motor noise, wear, and reduce motor efficiency. Efforts to address these problems have focused on skewing or offsetting the magnets, changing the ratio between poles and slots, or rotor displacement.

### SUMMARY OF THE INVENTION

The present invention provides an electric motor using the opposed magnet arrays of this architecture while having substantially reduced torque ripple and cogging, possible through the use of offset and overlapping stator coils. A slotted core ring and a division of the windings between sides of the core ring preserve the short magnetic path lengths with high magnetic permeability and high torque density of this design while being readily adapted to existing magnet structures.

In one embodiment, then, the invention provides an electric motor having a permanent magnet assembly having a first magnet array of circumferentially spaced permanent magnets in opposition to a second magnet array of circumferentially spaced permanent magnets. The motor further has a coil assembly (mounted for relative rotation with the permanent magnet assembly) positioned between the first magnet array and second magnet array, the coil assembly having a first coil array of circumferentially spaced coils facing the first magnet array and a second coil array of circumferentially spaced coils facing the second magnet array. The coils of the first coil array overlap the coils of the second array and are shifted angularly about the axis of rotation with respect to coils of the second coil array.

It is thus a feature of at least one embodiment of the invention to provide a new coil array design that can substantially reduce torque ripple and cogging torque while employing standard permanent magnet rotors.

The individual permanent magnets of the first and second magnet arrays may have an angular extent matching an angular extent of individual coils of the first and second coil array.

It is thus a feature of at least one embodiment of the invention to reduce torque ripple and cogging torque or the need to skew the magnets or coils.

The magnets of the first and second magnet arrays may be angularly aligned about the axis of rotation.

It is thus a feature of at least one embodiment of the invention to preserve short magnetic path length through the stator.

The electric motor may have pairs of coils including at least one coil from the first coil array and one coil from the second coil array that are electrically in series or parallel.

It is thus a feature of at least one embodiment of the invention to allow excitation of the offset coils of the second coil array using the same power waveforms that drives the first coil array.

The coils of the first coil array and second coil array may have equal circumferential spacing and the coils of the first array may be shifted angularly with respect to the second coil array by half of the equal circumferential spacing.

It is thus a feature of at least one embodiment to provide a mechanically simple rotor design suitable for a wide variety of applications.

The number of coils in the first coil array may be equal to the number of coils in the second coil array and evenly divisible by three.

It is thus a feature of at least one embodiment of the invention to provide a motor that can be used with standard three-phase drive power from a line source or a motor controller.

The electric motor may further include a core ring having interleaved radially extending notches for receiving the coils recessed into opposite sides of the core ring, wherein the core ring material has a relative permeability of greater than 100.

It is thus a feature of at least one embodiment of the invention to provide a core operating with the magnetic circuit of the staggered coils.

The core ring may be composed of identical interfitting segments.

It is thus a feature of at least one embodiment of the invention to provide a core ring composed of small volume soft magnetic composites to which the necessary pressures for manufacture can be practically applied.

The permanent magnets of the first permanent magnet array may be opposed to permanent magnets of the second permanent magnet array along a direction parallel to the axis of rotation.

It is thus a feature of at least one embodiment of the invention to provide an axial flux motor preserving short magnetic path lengths.

The core ring may be adapted to receive the coils of the first coil array and the coils of the second coil array to provide an assembly with a total axial width equal to twice the axial width of the coils.

It is thus a feature of at least one embodiment of the invention to preserve the short axial width of the axial field motor.

In one embodiment, the electric motor may further include at least two drive circuits providing a multiphase electrical output with different phases of the first drive circuit providing power to different coils in the first coil array only and different phases of the second drive circuit providing power to different coils in the second coil array only.

It is thus a feature of at least one embodiment to exploit the staggered coil arrays to accommodate redundant drive circuits, each drive circuit alone being sufficient to operate the motor subject to increased torque ripple and cogging torque.

These particular objects and advantages may apply to only some embodiments falling within the claims and thus do not define the scope of the invention.

### BRIEF DESCRIPTION OF THE DRAWINGS

FIG. 1 is an exploded perspective view of the major components of a motor constructed according to the present invention showing a stator coil ring having staggered overlapping coils flanked by permanent magnet rotors rings joined on a common shaft;

FIG. 2 is a fragmentary exploded perspective view of the stator coil ring of FIG. 1 showing the coils in alignment within grooves on a stator coil ring;

FIG. 3 is a figure similar to that of FIG. 2 showing the coils installed in the grooves on the core ring;

FIG. 4 is a side, cross-sectional, fragmentary view of the stator coil ring unrolled to show the various dimensions and connections of coils to a three-phase power supply; and

FIG. 5 is a side elevational view of the rotor and stator of FIG. 1 showing a split power supply for high reliability.

### DETAILED DESCRIPTION OF THE PREFERRED EMBODIMENT

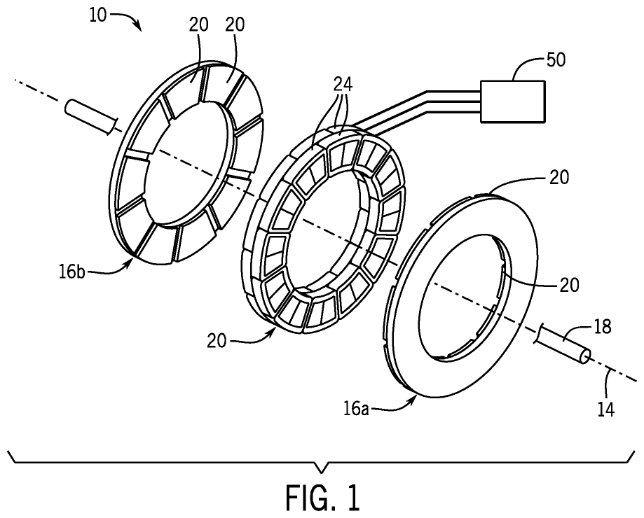

Referring now to FIG. 1, an electric motor 10 according to one embodiment of the present invention may provide for a ring-shaped stator 12 centered about and perpendicular to a rotational axis 14. The stator 12 is flanked by corresponding ring-shaped rotors 16a and 16b also centered on and perpendicular to the rotational axis 14. The rotors 16a and 16b are attached to a common shaft 18 to rotate therewith about the rotational axis 14 as supported by bearings in a manner generally understood in the art.

The rotors 16a and 16b support multiple permanent magnets 20 being, in one embodiment, each sectors of an annulus and arrayed circumferentially at equal angular spacings about the rotational axis 14. In one nonlimiting embodiment, the permanent magnets 20 will be symmetric about a radial axis with respect to the rotational axis 14 and thus without skew. The polarity of adjacent magnets 20 as one moves circumferentially about a rotor 16 is reversed to provide inwardly facing and alternating north or south poles, respectively. In one embodiment each magnet 20 on the rotor 16a is angularly aligned along a line parallel to the rotational axis 14 with a corresponding magnet 20 on the opposed rotor 16b, and the magnetization of such opposed magnets 20 will have a same orientation (that is, with an inwardly facing north pole on rotor 16a facing an inwardly facing south pole on rotor 16b).

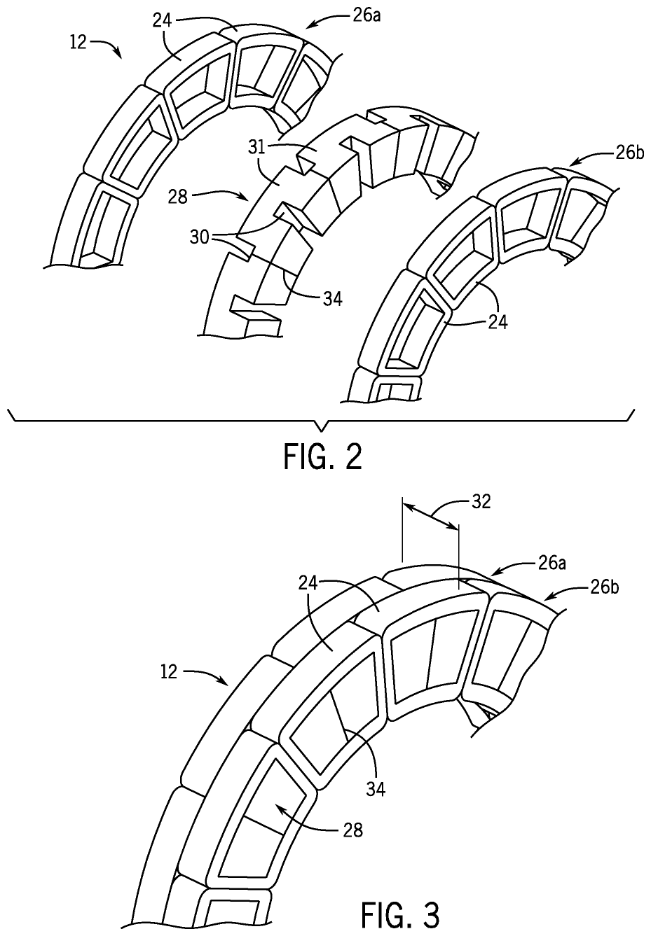

Referring also to FIGS. 2 and 3, the stator 12 may provide for multiple electrical coils 24, each wound about an axis parallel to the rotational axis 14 and distributed circumferentially about the stator 12. In one nonlimiting example, each coil 24 may have a same angular extent and radial extent as the corresponding magnets 20 and thus generally have an outline conforming to a segment of an annulus. In this regard, the electrical coils 24 may also be symmetric about a radial axis with respect to the rotational axis 14.

The electrical coils 24 are divided into two sets 26a and 26b each separately tiling an entire circumference of the stator 12 within planes positioned, respectively, on opposite sides of an annular core 28 having a common center with the stator. The coils of set 26a may have their centers, defined as a central point within a perimeter defined by the coil windings, offset in angle about the rotational axis 14 from corresponding centers of coils 24. In one nonlimiting example, this offset may be an angle equal to half of an angular spacing between centers of coils 24. In this regard, the coils 24 of set 26a overlap the coils 24 of set 26b viewed along a direction parallel to the rotational axis.

As is understood in the art, the coils 24 will be wound of multiple turns of an externally insulated conductor such as an enameled copper wire and will produce a magnetic field extending aligned with the magnetic field between the magnets 20 of the rotors 16 when conducting current.

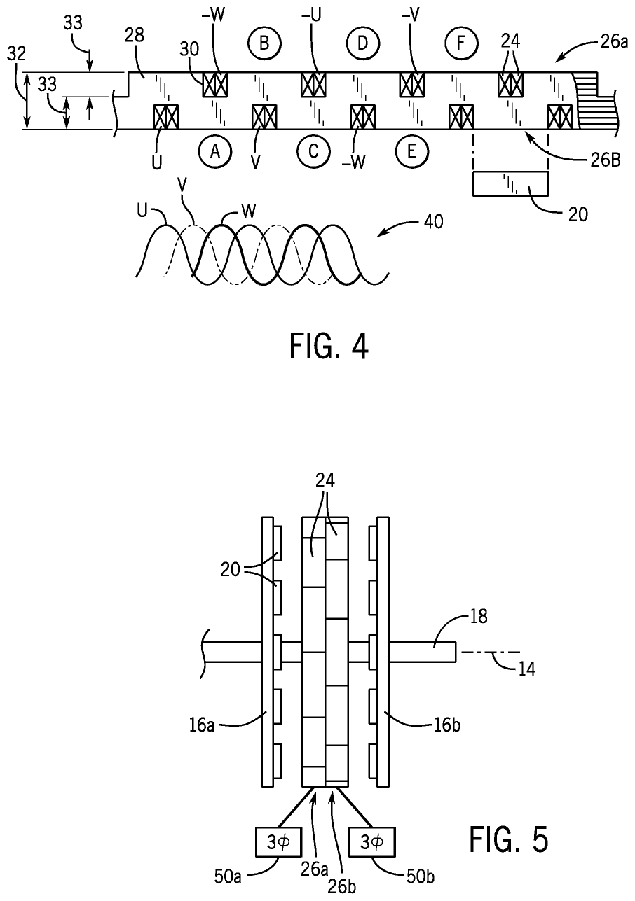

The annular core 28 supports the coils 24 on opposite sides and has radially extending slots 30 on opposite faces to receive radially extending portions of adjacent coils 24 therein so that material of the annular core 28 fills the space within the coils 24. The slots 30 on opposite faces of the annular core 28 are offset to match the angular offset of the coils 24 between sets 26a and 26b and have a depth (also shown in FIG. 4) to allow the coils 24 to fit together axially so that the total axial width 32 of the stator 12 is substantially equal to twice the axial width 33 of a given coil 24. In this respect, the axially inner edges of the slots 30 of both opposite faces of the annular core 28 lie along a common plane.

The annular core 28 may be composed of mechanically-decoupled identical modular elements 31 having perimeters approximating an annular sector and having radially extending seam lines 34 between the modular elements 31, for example, bifurcating an enclosed area of a coil 24 as shown in FIG. 3 for the coils of set 26b or at the interface between windings of different coils 24 for the coils 24 of set 26a (best seen in FIG. 2). Alternatively, the annular core 28 may be mechanically continuous (without seams 34) following a serpentine circumferential path possible because of the greater circumferential spacing between the slots 30 than the circumferential width of the slots 30. In some embodiments, the annular core 28 may include a backer plate comprising a magnetically continuous ring in a plane perpendicular to the rotational axis 14.

The material of the annular core 28 is desirably a material of high relative permeability having a relative permeability of over 100, for example, including iron, iron oxides, and alloys of iron, some of which may have relative permeabilities of greater than 1000 or greater than 10,000. In one embodiment, the annular core 28 may be formed of a so-called soft magnetic composite material constructed of compressed ferromagnetic powder permitting the manufacture of complex shapes. Alternatively, the annular core 28 may be constructed of laminated steel or the like, with the laminations oriented, for example, to extend circumferentially and stacked radially to reduce eddy currents within the material of the annular core 28.

The angular offset of the coils 24 between the sets 26a and 26b has the effect of decreasing torque ripple (variations or oscillations in torque generated by electrical power-applied motor during its rotation on a constant load) and cogging torque (variations or oscillations in torque when the rotor is rotated in the absence of electrical power and caused by magnetic attraction between the permanent magnets and the material of the annular core 28 at no-load) while substantially matching the performance of a similar electrical motor having a comparable number of coil windings. The reduced torque ripple and cogging torque are comparable to a similar electrical motor having coils and magnets with half the angular extent (half the pitch) and thus twice as many magnets and coils, while avoiding possibly lower fill factor caused by necessary insulation and coil spacing or non-optimal magnet sizes. In simulations, this above-described design with 10 magnets 20 and 24 coils 24 reduces torque ripple by 87% compared to a comparable 10 magnet motor, for example, having only 12 coils.

Referring now to FIG. 4, in one nonlimiting example, the coils 24 may be driven by a three-phase electrical power waveform 40 having sinusoidal phases u, v, and w separated in phase by 120°. For each sequence of six angularly adjacent coils 24, labeled A-F, with coils A, C, and E being in set 26b and coils labeled B, D, and F being in set 26a, the phases may be connected to the coils as follows:

TABLE I

| Coil | Phase connection |
|---|---|
| A | u |
| B | −w |
| C | v |
| D | −u |
| E | w |
| F | −v |

where minus signs indicate a connection that causes current to flow to the coil 24 in an opposite cyclic direction with respect to current flow without the minus sign.

It will be appreciated from this chart that coils A and D may be connected electrically in series as is also the case with coils B and E and coils C and F for simple electrical configuration and without the need for additional synthesized current phases for the offset coils 24. The electrical power waveforms 40 may be obtained from a three-phase line voltage or a synthesized waveform from a solid-state motor drive or the like.

Referring now to FIG. 5, in one embodiment, identical waveforms 40 may be obtained from electrically independent solid-state motor drives 50a and 50b, with solid-state motor drive 50a driving only the coils 24 from set 26a and solid-state drive 50b driving only the coils from set 26b. In the event of failure of one of the solid-state drives 50, continued motor operation can be obtained (foregoing the benefits of reduced torque ripple and cogging), and possibly with a lower power, by using the coils 24 and only one of the sets 26.

The present invention has been described in the context of an axial field motor. However, these principles can equally be applied to a radial field motor having opposed magnet structures analogous to those of the rotors 16a and 16b. While there are benefits to having a stator 12 with the coils on it in terms of applying electrical power to the stator 12, it will be appreciated that the position of the magnets 20 and the coils 24 can be reversed with respect to which element rotates. The position of the magnets on the rotors 16b and 16a may also be arranged to have opposing fields, for example, opposed magnet faces that both present north poles toward each other using the same principles described above. Generally, the inventors contemplate that the number of turns in the coils 24 between the sets 26a and 26b may be varied as well as their sizes and that the offset may not be one half of the coil angular pitch provided there is an offset typically within plus or minus 10% of this offset and that this technique may be used in combination with other ripple reducing and cogging torque reducing techniques including skew of the magnets.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. An electric motor comprising
a permanent magnet assembly having a first magnet array of circumferentially spaced permanent magnets in opposition to a second magnet array of circumferentially spaced permanent magnets;
a coil assembly positioned between the first magnet array and second magnet array and providing a first coil array of circumferentially spaced coils facing the first magnet array and a second coil array of circumferentially spaced coils facing the second magnet array; one of the coil assembly and permanent magnet assembly supported by bearings to provide relative rotation therebetween about an axis of rotation; and
wherein coils of the first coil array overlap the coils of the second coil array and are shifted angularly about the axis of rotation with respect to coils of the second coil array.

2. The electric motor of claim 1 wherein individual permanent magnets of the first and second magnet arrays have an angular extent matching an angular extent of individual coils of the first and second coil arrays.

3. The electric motor of claim 1 wherein the magnets of the first and second magnet arrays are angularly aligned about the axis of rotation.

4. The electric motor of claim 1 wherein pairs of coils including one coil from the first coil array and one coil from the second coil array are electrically in series or parallel.

5. The electric motor of claim 1 wherein coils of the first coil array and second coil array have equal circumferential spacing and wherein the coils of the first array are shifted angularly with respect to the second coil array by half of the equal circumferential spacing.

6. The electric motor of claim 1 wherein a number of coils in the first coil array is equal to the number of coils in the second coil array and evenly divisible by three.

7. The electric motor of claim 1 further including a core ring having interleaved radially extending notches for receiving the coils recessed into opposite sides of the core ring, wherein the core ring material has a relative permeability of greater than one-hundred.

8. The electric motor of claim 7 wherein the core ring is adapted to receive the coils of the first coil array and the coils of the second coil array to provide an assembly with a total axial width equal to twice the axial width of the coils.

9. The electric motor of claim 7 wherein the core ring is composed of identical inter fitting segments.

10. The electric motor of claim 7 wherein the core ring is composed of a material selected from the group consisting of iron, iron oxide, and alloys of iron.

11. The electric motor of claim 7 wherein the core ring is comprised of a material fabricated from a compacted powder.

12. The electric motor of claim 1 wherein the permanent magnets of the first permanent magnet array are opposed to permanent magnets of the second permanent magnet array along a direction parallel to the axis of rotation.

13. The electric motor of claim 1 further including at least one drive circuit providing a multiphase electrical output with different phases providing power to different coils of the first and second coil array and provide a magnetic field rotating about the axis of rotation.

14. The electric motor of claim 13 further including at least two drive circuits providing a multiphase electrical output with different phases of the first drive circuit providing power to different coils in the first coil array only and different phases of the second drive circuit providing power to different coils in the second coil array only.

15. The electric motor of claim 1 wherein the magnets and coils are symmetric about lines of radius about the axis of rotation.

16. The electric motor of claim 1 including a core ring fitting between the first and second coil array providing a circumferentially planar flux path.
